(19) United States
(12) Patent Application Publication
(10) Pub. No.: US 2011/0255548 A1
(43) Pub. Date: Oct. 20, 2011

(54) GATEWAY-BASED AMI NETWORK

(75) Inventor: MATTHEW JOHNSON, Spokane, WA (US)

(73) Assignee: Itron, Inc., Liberty Lake, WA (US)

(21) Appl. No.: 12/761,746

(22) Filed: Apr. 16, 2010

(51) Int. Cl. H04L 12/56

(52) U.S. Cl. 370/401

(57) ABSTRACT

Apparatus and methodology provide communications between a utility consumption meter and a utility provider at least in part by way of Internet Protocol (IP) based communications. A gateway device, coupled via either wired or wireless communications links to a utility consumption meter, serves as an interface between the utility consumption meter and a central utility provider server. Communications between the gateway and the central utility provider server are by wired or wireless IP-based communications. At least a portion of the IP-based communications may be by way of public broadband networks operated by Internet Service Providers (ISPs), thereby avoiding the installation of specifically purposed collection infrastructure.

### FIELD OF THE INVENTION

The present subject matter relates to Advanced Metering Infrastructure (AMI). More particularly, the present subject matter relates to advanced apparatus and methodologies for collecting, transmitting, and distributing utility consumption data among interested parties.

### BACKGROUND OF THE INVENTION

Advanced Metering Infrastructure (AMI) refers to systems that are capable of collecting detailed energy usage data on a frequent basis. Collection of more timely and granular data enables utilities to support time-based pricing and demand response programs, educate customers on energy consumption, and potentially alter usage patterns. AMI data may be collected much more frequently, and the type of data collected may be much more complex than in a typical Automated Meter Reading (AMR) system.

Commonly used AMI networks depend heavily upon utility providers deploying a collection infrastructure network to provide communications with metering devices. Typically data collectors in such infrastructures are backhauled over private or commercial networks. Increasingly, however, broadband connectivity is becoming nearly universal, which may afford utility providers opportunities to bypass dedicated collection networks by sending meter reading information directly across public networks to the utility and other data consumers. Given such opportunities, it would be advantageous to provide apparatus and methodologies to take better advantage of available and/or developing infrastructures.

While various implementations of advanced metering infrastructures have been developed, and while various combinations of data transferring systems have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, improved apparatus and methodologies for collecting, transmitting, and distributing utility consumption data among interested parties are provided.

One present exemplary embodiment of the present subject matter relates to an Advanced Metering Infrastructure (AMI) comprising a gateway, at least one utility consumption measuring device coupled for communications with the gateway, an Internet Protocol (IP) based communications network, and at least one utility central facility server coupled for communications over the network, wherein the gateway is coupled for IP-based communications with the network whereby data may be exchanged between the at least one utility central facility server and the at least one utility consumption measuring device. In certain embodiments communications between the gateway and network may be by wired or wireless communications.

In particular alternative embodiments, the gateway may be configured for communications with a plurality of consumption measuring devices. In more particular alternative embodiments, the gateway may communicate wirelessly or via wired communications. In certain particular optional embodiments, the gateway may be coupled for two-way IP-based communications with the network.

Another present exemplary embodiment of the present subject matter also may relate to a gateway comprising a meter interface, a microprocessor, a memory associated with the microprocessor, and a network interface. Preferably, such meter interface is configured for communications with at least one utility consumption measuring device, the network interface is configured for Internet Protocol (IP) based communications with an IP based communications network, and the microprocessor is configured to direct data flow among the memory, the meter interface, and the network interface.

In certain present alternative embodiments, the gateway may be configured for wireless communications with the at least one utility consumption measuring device while in other embodiments the gateway may be configured for wired communications with the at least one utility consumption measuring device. In particular other alternative embodiments, the network interface may be configured for wireless communications with an IP based communications network while in other optional embodiments the network interface may be configured for wired communications with an IP based communications network. In more particular alternative embodiments, the microprocessor may be configured to direct two-way data flow.

The present subject matter equally relates to corresponding and/or related methodology, an example of which relates to a method for providing communications between a utility consumption measuring device and a utility provider. One present exemplary embodiment relates to a method comprising coupling a utility consumption measuring device to a gateway for Internet Protocol (IP) based communications with an Internet Service Provider (ISP), and coupling a utility provider central facility server via an Internet Protocol (IP) based communications network to the ISP.

In particular alternative embodiments, the present method may provide for wireless coupling between the utility consumption measuring device and gateway while in other alternative embodiments the method may provide for wired communications between the utility consumption measuring device and gateway. In various optional embodiments, a present gateway of the exemplary methodology may correspond to such as those embodiments of a gateway as set forth in various exemplary apparatus embodiments herein.

In certain further optional embodiments, the present method may further comprise transmitting utility consumption measuring device configuration instructions from the utility provider central facility server via the gateway. In particular alternative embodiments, a present exemplary embodiment of the present method may provide coupling a plurality of utility consumption measuring devices to a gateway where in certain embodiments the consumption measurement devices may be like type device and in alternative embodiments diverse type devices.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects herein, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a block diagram of an advanced metering infrastructure (AMI) incorporating the present subject matter; and

FIG. 2 is a block diagram of an exemplary gateway device useful in implementing the present technology.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with improved apparatus and methodologies for collecting, transmitting, and distributing utility consumption data among interested parties.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

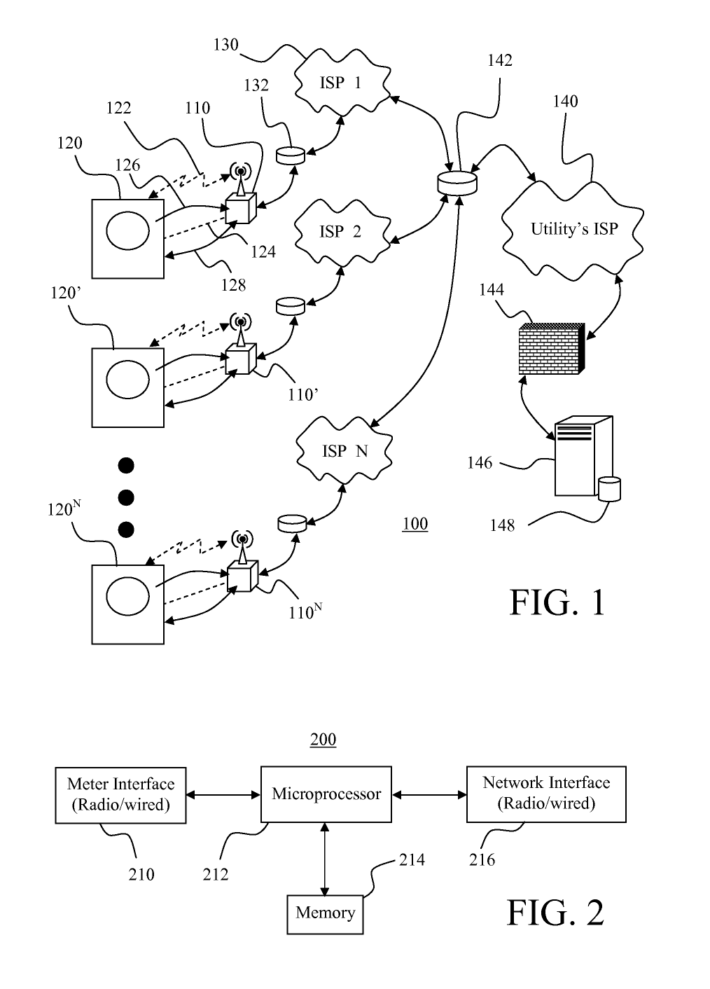

Reference will now be made in detail to the presently preferred embodiments of the subject Gateway-Based AMI Network. Referring now to the drawings, FIG. 1 illustrates a block diagram of an exemplary Advanced Metering Infrastructure (AMI) generally 100 incorporating the present subject matter.

Several considerations differentiate the implementation of AMI 100 in accordance with present technology from prior standard such networks. In a first aspect, gateways 110, 110′, 110^{N} are provided at a utility service location to convert information from meters 120, 120′, 120^{N} to an Internet Protocol (IP) based communications protocol. Respective communications connections from meters 120, 120′, 120^{N} to gateways 110, 110′, 110^{N} may correspond to either representative wireless connection 122 or representative wired connection 124. In addition, connections 122, 124 may correspond to one-way connections 126 from meters 120, 120′, 120^{N} or two-way connections 128 as required or as appropriate or desired. Those of ordinary skill in the art will appreciate that each of the gateways 110, 110′, 110^{N} provide the same combination of communications possibilities although labeling of connections is not included in order to avoid unnecessary clutter of the present illustrations.

Those of ordinary skill in the art should also appreciate that, in accordance with the present subject matter, each of the alternative communications options may be paired with each of the alternate communications mediums, and that the same combination is not required for each situation. That is, one-way communications may per present subject matter be provided in an individual configuration over wireless or wired communications channels or, alternatively, two way communications may be similarly provided over either wireless or wired communications channels.

A second aspect of the present technology provides that information from, or alternately to and from, meters 120, 120′, 120^{N} will now be routed from the various gateway 110, 110′, 110^{N} devices to and/or from the utility over a combination of private, i.e., consumer, networks including representative private ISP 130 via appropriate exemplary coupling devices 132, and public networks representatively illustrated as coupling device 142 to a utility via their own ISP 140.

As with all transmissions that occur across public networks, routing and security concerns should be addressed. In accordance with present technology, security measures may be addressed at least in part by way of the provision of a firewall 144 providing protection for the utility's central facility including server 146 and associated data storage 148.

Further in accordance with present technology, data communication between utility consumption sites and utility providers, whether such is one-way or two-way and whether conducted wirelessly or via wired communications or combinations thereof, may be configured to operate under multiple methodologies. For example, in exemplary configurations, a network configured in accordance with present technology may be operated as a Polling-Based Network or as a Push-Based System.

When operated as a Polling-Based Network, acquisition of meter readings, in a first exemplary configuration, may be controlled from the utility's systems by polling gateways 110, 110′, 110^{N} to return time-stamped information read from meters 120, 120′, 120^{N} that an individual gateway 110, 110′, 110^{N} holds in its memory. Alternatively, in a second exemplary configuration, the utility system may control gateways 110, 110′, 110^{N} to request the most current information from it associated meter 120, 120′, 120^{N}, as well as any other information that may be held in the meter's memory that the utility may request. Such request may be made either concurrently with a present communication or from a previous communication. Those of ordinary skill in the art will appreciate without requiring additional discussion that multiple requests can be sent and handled by multiple software and/or hardware processors to increase the throughput of such polling approach.

When the AMI in accordance with present technology is operated as a Push-Based System embodiment, the various gateway devices may be configured by the utility to periodically push readings and other relevant information including, for example, alarms, tampers, etc., to the utility's head-end systems. Optionally, as part of a push, the individual gateways 110, 110′, 110^{N} may check for pending requests from the head-end to send any other information that the utility desires. Responses for such requests may come from the gateway's memory or from interrogation of the meter or the meter's own memory. Configuration of the gateway or meter may also be undertaken as a portion of such exemplary embodiment.

In accordance with present technology, when the AMI is operated under either the polling or push modes, a multicast of meter information may be provided. In that light, besides the utility subscribing to the information, other multicast consumers might include an In Home Display or other energy monitoring or management system(s) that has Internet connectivity.

With reference to present FIG. 2, there is illustrated a block diagram of a present exemplary gateway device 200 useful in implementing the present technology. In order to implement the present technology, there is provided a gateway device 200 that includes an interface 210 to communicate with the meter(s) 120, a network interface 216, and a processor 212 with associated memory 214. Meter interface 210 may provide wireless and/or wired communications with its associated meter(s).

At this juncture it should be noted that communication with plural meters 120 by a single gateway device 200 is contemplated within the scope and content of the present technology. For example, while the present technology seeks to leverage the expanding availability of broadband connections at utility consumption locations, it is to be understood and appreciated by those of ordinary skill in the art that not every consumption site will be so equipped. In such instances, provisions may be made in accordance with the present subject matter for an individual gateway device 200 to communicate either wirelessly or via wired connection with multiple relatively close-by meters 120 and to provide communications therebetween and with the utility's central facilities over an available broadband connection. In those instances where a gateway device 200 may provide communication for other meters 120, a separate portion of memory 214 may be assigned per present subject matter to such meter 120. In an exemplary such configuration, a single gateway device 200 may, for example, provide communications for all or a portion of an apartment complex where individual apartments are billed separately for utility consumption but where wireless Internet service may be provided to the individual complex apartments as a provided service. In such instances, only a single Internet connection may be provided and may be made available for communications with the utility provided.

As a further alternative per the present subject matter, it should be noted that communication with plural meter types by a single gateway device 200 is also contemplated with the present technology. That is, a single utility consumption site may be provided with electricity, water, and gas meters such that the present technology may provide communications via a single gateway device 200 for each such meter type. Further, data from such different meters may be directed to different service providers at different central facilities but each coupled by way of gateway device 200 and available IP-based networks that may include one or more Internet Service Providers (ISPs).

Another exemplary aspect of certain embodiments of the present technology is that since meter data frequently must be accurately time-stamped, gateway device 200 in some embodiments preferably should provide a source for maintaining accurate time. An optional internal clock circuit (not separately illustrated) may be included or a process maintained by microprocessor 212 to achieve such functionality. In either case, per present subject matter, the use of a synchronizing time source, such as Network Time Protocol (NTP) may be made available to synchronize the internal clock.

The present subject matter permits exploitation of public broadband networks for the collection and transmission of meter reading data, avoiding the installation of specifically purposed collection infrastructure. Such present approach reduces potential infrastructure cost and increases deployment flexibility for utilities.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure and claims do not preclude inclusion of such modifications, variations, and/or additions to the present subject matter as would be readily apparent to one of ordinary skill in the art.

What is claimed is:

1. An Advanced Metering Infrastructure (AMI), comprising:
a gateway;
at least one utility consumption measuring device coupled for communications with said gateway;
an Internet Protocol (IP) based communications network; and
at least one utility central facility server coupled for communications over said network,
wherein said gateway is coupled for IP-based communications with said network whereby data may be exchanged between said at least one utility central facility server and said at least one utility consumption measuring device.

2. An AMI as in claim 1, wherein said gateway is couple for wireless communications with said network.

3. An AMI as in claim 1, wherein said gateway is couple for wired communications with said network.

4. An AMI as in claim 1, wherein said gateway is configured for communications with a plurality of consumption measuring devices.

5. An AMI as in claim 4, wherein said gateway is configured for wireless communications with said plurality of consumption measuring devices.

6. An AMI as in claim 4, wherein the gateway is configured for wired communications with said plurality of consumption measuring devices.

7. An AMI as in claim 1, wherein said gateway is coupled for two-way IP-based communications with said network.

8. An AMI as in claim 1, wherein said gateway comprises a utility consumption measuring device interface, a network interface, a microprocessor, and a memory associated with said microprocessor, with said microprocessor configured to direct data flow among said memory, said utility consumption measuring device interface, and said network interface.

9. A gateway, comprising:
a meter interface, configured for communications with at least one utility consumption measuring device;
a microprocessor;
a memory associated with said microprocessor; and
a network interface, configured for Internet Protocol (IP) based communications with an IP based communications network;
wherein said microprocessor is configured to direct data flow among said memory, said meter interface, and said network interface.

10. A gateway as in claim 9, wherein said meter interface is configured for wireless communications with at least one utility consumption measuring device.

11. A gateway as in claim 9, wherein said meter interface is configured for wired communications with at least one utility consumption measuring device.

12. A gateway as in claim 9, wherein said network interface is configured for wireless communications with an IP based communications network.

13. A gateway as in claim 9, wherein said meter interface is configured for wired communications with an IP based communications network.

14. A gateway as in claim 9, wherein said microprocessor is configured to direct two-way data flow.

15. A method of providing communications between a utility consumption measuring device and a utility provider without requiring the installation of specifically purposed collection infrastructure, comprising:
coupling a utility consumption measuring device to a gateway for Internet Protocol (IP) based communications with an Internet Service Provide (ISP); and
coupling a utility provider central facility server to the ISP via an Internet Protocol (IP) based communications network.

16. A method as in claim 15, wherein coupling between the utility consumption measuring device and gateway is conducted wirelessly.

17. A method as in claim 15, wherein coupling between the utility consumption measuring device and gateway is conducted by wired communication.

18. A method as in claim 15, further comprising transmitting via the gateway utility consumption measuring device configuration instructions from the utility provider central facility server to a utility consumption measuring device.

19. A method as in claim 15, wherein coupling a utility consumption measuring device to a gateway comprises coupling a plurality of utility consumption measuring devices to a gateway.

20. A method as in claim 19, wherein coupling a plurality of utility consumption measuring devices comprises coupling a plurality of like type utility consumption measuring devices.

21. A method as in claim 19, wherein coupling a plurality of utility consumption measuring devices comprises coupling a plurality of diverse type utility consumption measuring devices.

22. A method as in claim 15, wherein the gateway comprises:
a meter interface, configured for communications with a utility consumption measuring device;
a network interface, configured for Internet Protocol (IP) based communications with an IP based communications network;
a microprocessor; and
a memory associated with such microprocessor, which microprocessor is configured to direct data flow among the memory, the meter interface, and the network interface.
